(19) United States
(12) Patent Application Publication
(10) Pub. No.: US 2021/0097241 A1
(43) Pub. Date: Apr. 1, 2021

(54) TEXT MATCHING SYSTEM

(71) Applicant: NTT DOCOMO, INC., Chiyoda-ku (JP)

(72) Inventors: Yutaro SHIRAMIZU, Chiyoda-ku (JP); Kousuke KADONO, Chiyoda-ku (JP)

(73) Assignee: NTT DOCOMO, INC., Chiyoda-ku (JP)

(21) Appl. No.: 17/043,394

(22) PCT Filed: Apr. 12, 2019
(86) PCT No.: PCT/JP2019/016044

§ 371 Date: Sep. 29, 2020

(30) Foreign Application Priority Data
Apr. 24, 2018 (JP) 2018-083319
Oct. 31, 2018 (JP) 2018-205476

(51) Int. Cl. G06F 40/40; G06F 16/332; G06F 16/33; G06F 16/903

(52) U.S. Cl. CPC G06F 40/40; G06F 16/90344; G06F 16/3344; G06F 16/3329

(57) ABSTRACT

A sentence matching system includes an input unit configured to input a sentence, a matching determination unit configured to determine matching between a sentence input by the input unit and a preset matching sentence, wherein the matching sentence is configured to be divided into a plurality of character string units and at least one of the character string units includes a plurality of candidates further divided into a plurality of character strings, and the matching determination unit determines the matching by treating the input sentence as divided into the plurality of character string units.

### TECHNICAL FIELD

The present invention relates to a sentence matching system that determines matching between an input sentence and a preset matching sentence.

### BACKGROUND ART

In the related art, dialog systems that input sentences based on speeches, operations, or the like of users and perform talking have been proposed. Artificial Intelligence Markup Language (AIML) describing rules for making automatic responses to sentences input using dialog systems are known.

### CITATION LIST

### Patent Literature

[Patent Literature 1] Japanese Unexamined Patent Publication No. 2017-49471

### SUMMARY OF INVENTION

### Technical Problem

In AIML, it is necessary to prepare matching sentences to match input sentences in advance. In AIML of the related art, in order to make appropriate automatic responses to input sentences, many matching sentences has to be prepared, and it is difficult to perform flexible matching.

An embodiment of the present invention has been devised in view of the foregoing circumstances and an objective of the present invention is to provide a sentence matching system capable of performing flexible sentence matching without requiring many matching sentences.

### Solution to Problem

To achieve the foregoing objective, according to an embodiment of the present invention, a sentence matching system includes: an input unit configured to input a sentence; and a matching determination unit configured to determine matching between the sentence input by the input unit and a preset matching sentence. The matching sentence is configured to be divided into a plurality of character string units and at least one of the character string units includes a plurality of candidates further divided into a plurality of character strings. The matching determination unit determines the matching by treating the sentence input by the input unit as divided into the plurality of character string units.

With the sentence matching system according to the embodiment of the present invention, a matching sentence of which a part includes a plurality of candidates divided into a plurality of character strings is used to determine matching. Accordingly, the matching can be determined without preparing a plurality of different matching sentences of which the part is different in advance. Accordingly, with the sentence matching system according to the embodiment of the present invention, many matching sentences are not necessary and it is possible to perform flexible sentence matching.

### Advantageous Effects of Invention

According to an embodiment of the present invention, matching can be determined without preparing a plurality of matching sentences of which a part is different in advance. Accordingly, according to an embodiment of the present invention, many matching sentences are not necessary and it is possible to perform flexible sentence matching.

### BRIEF DESCRIPTION OF DRAWINGS

FIG. 1 is a diagram illustrating a configuration of an automatic response system which is a sentence matching system according to an embodiment of the present invention.

FIG. 2 is a diagram illustrating an example of a rule for an automatic response.

FIG. 3 is a diagram schematically illustrating a configuration of a matching sentence.

FIG. 4 is a diagram illustrating another example of a rule for an automatic response.

FIG. 5 is a flowchart illustrating a process performed by the automatic response system which is a sentence matching system according to an embodiment of the present invention.

FIG. 6 is a diagram illustrating a hardware configuration of the automatic response system which is a sentence matching system according to an embodiment of the present invention.

FIG. 7 is a diagram illustrating a plurality of candidates when the plurality of candidates included in a matching sentence are read to a main memory step by step.

FIG. 8 is a diagram schematically illustrating a configuration of a matching sentence.

### DESCRIPTION OF EMBODIMENTS

Hereinafter, embodiments of a sentence matching system according to the present invention will be described in detail with reference to the drawings. Further, in description of the drawings, substantially the same elements are denoted by the same reference numerals, and a description thereof may be omitted.

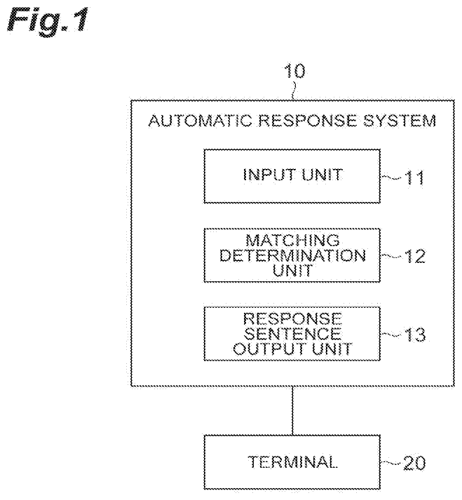

FIG. 1 illustrates an automatic response system 10 which is a sentence matching system according to the embodiment. The automatic response system 10 is a system that receives a sentence (a text, a character string) from a terminal 20 and performs a response according to the received sentence. For example, the automatic response system 10 performs talking with the terminal 20 using sentences based on a preset scenario. When the automatic response system 10 performs a response, the automatic response system 10 determines matching between an input sentence and a preset matching sentence, as will be described in detail below. In the embodiment, basically, Japanese sentences will be described as examples. Here, for sentences other than Japanese sentences, matching can be determined similarly. The automatic response system 10 is realized by, for example, a server device.

The terminal 20 is a device that is used by a user and is equivalent to, for example, a mobile phone (including a smartphone) or a personal computer (PC). The terminal 20 can communicate with the automatic response system 10 or the like via a communication network (for example, a mobile communication network). The terminal 20 receives an operation from the user to input a sentence, and transmits the input sentence to the automatic response system 10. The terminal 20 receives a response sentence transmitted from the automatic response system 10 in response to the transmission of the sentence. The terminal 20 outputs the response sentence, for example, by displaying the response sentence.

The sentence transmitted from the terminal 20 to the automatic response system 10 may be a sentence obtained by performing voice recognition on a voice (a speech) arriving from the user. The voice recognition may be performed by the tenninal 20 or may be performed by a device other than the terminal 20. The response sentence received from the automatic response system 10 may also be output by a voice. In this way, automatic response of a voice can be realized.

Next, a function of the automatic response system 10 according to the embodiment will be described. As illustrated in FIG. 1, the automatic response system 10 includes an input unit 11, a matching determination unit 12, and a response sentence output unit 13.

The input unit 11 is a function unit of inputting a sentence. The input unit 11 receives and inputs a sentence transmitted from the tenninal 20. The input unit 11 outputs an input sentence which is the sentence input by the input unit 11 to the matching determination unit 12. The input unit 11 may input the sentence in another manner other than the foregoing manner. For example, the input unit 11 may receive a voice transmitted from the terminal 20, perform voice recognition on the received voice, and acquire and input a sentence which is a result of the voice recognition. In this case, the input unit 11 performs the voice recognition using any known voice recognition method.

The matching determination unit 12 is a function unit that determines matching between the input sentence input by the input unit 11 and a preset matching sentence. The matching sentence is configured to be divided into a plurality of character string units and at least one of the character string units includes a plurality of candidates further divided into a plurality of character strings. The matching determination unit 12 determines the matching by treating the sentence input by the input unit as divided into the plurality of character string units.

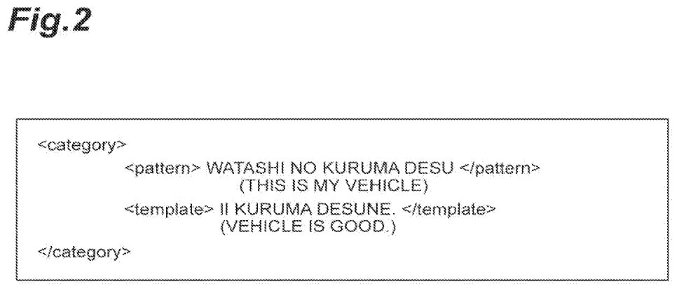

An automatic response in the automatic response system 10 is made using, for example, a framework of AIML. Here, the following description is not necessarily included in the framework of AIML of the related art (is different from AIML of the related art). That is, in the automatic response system 10, rules for automatic responses are stored in advance. An example of the rule is illustrated in FIG. 2. One rule is defined in a portion between a <category>tag and <category>tag. A sentence written in a portion between a <pattern>tag and <pattern>tag is a matching sentence. In the example of FIG. 2, “Watashi no kuruma desu (This is my vehicle)” is a matching sentence. The matching determination unit 12 determines matching between an input sentence and a matching sentence for each rule.

A sentence written in a portion between a <template>tag and </template>tag is a response sentence output as an automatic response.

In the example of FIG. 2, “Ii kuruma desune. (Vehicle is good)” is a response sentence. In this way, in the automatic response system 10, a matching sentence and a response sentence are associated for each rule. In the automatic response system 10, a plurality of rules for the foregoing automatic responses are stored. When the matching determination unit 12 determines that an input sentence matches a matching sentence, a response sentence (defined by the same rule as the matching sentence) associated with the matching sentence is output.

The matching sentence may be a sentence in which a plurality of candidates are included in a part. For example, for a part [iro (color)] in a sentence “[Iro] ga suki ([Color] is favorite),” a sentence that includes a plurality of candidates such as “karasu no nure ba iro (color of a crow with wet feathers),” “wine red,” and “ocean blue” may be set as a matching sentence.

The matching sentence is configured to be divided into a plurality of character string units, as described above. For example, morphemes are served as the character string units. The division into the units can be performed through a method of the related art, for example, morpheme analysis. Here, the character string units may be anything other than morphemes, for example, words. A part including a plurality of candidates (in the foregoing example, the part [iro (color)]) is also one unit of a matching sentence maintaining information indicating all of the candidates (a group).

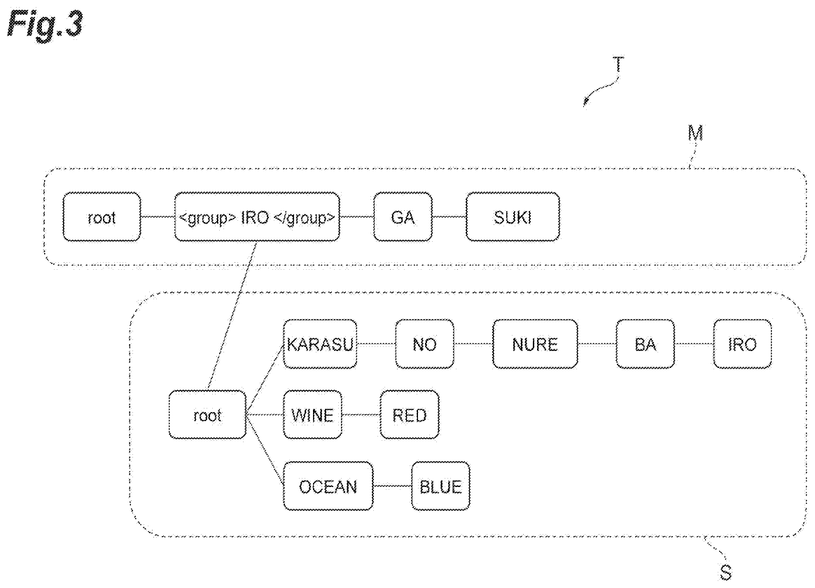

The matching sentence is expressed by, for example, a trie. FIG. 3 schematically illustrates an example of a structure of a matching sentence T according to the embodiment. The matching sentence T includes a main tree M and a sub-tree S. The main tree M is a common character string in the matching sentence T irrespective of a plurality of candidates. The sub-tree S is a portion of a plurality of candidates.

A node “root” is provided at the heads of the main tree M and the sub-tree S. In order in which a sentence is configured, each of the main tree M and the sub-tree S is configured such that nodes of the character string units are connected in order. In a part including a plurality of candidates for the main tree M, a node in which a description (in the example of FIG. 3, “iro (color)”) indicating all of the candidates (a group) is made is provided between a <group>tag and a </group>tag. “root” of the corresponding sub-tree S is connected to the node. A node of a head unit of each of the plurality of candidates is connected to “root” of the sub-tree S. As described above, each of the plurality of candidates is configured to be divided into a plurality of units. Here, a candidate formed by one unit may be included in the sub-tree S. As described above, the matching sentence T is configured such that the character string units are connected at two stages.

In the example of FIG. 3, only one sub-tree S is included in one matching sentence T, but a plurality of sub-trees S may be included. That is, one matching sentence T may have a plurality of parts, each of which including a plurality of candidates. On the other hand, the sub-tree S is not included in the matching sentence T that has no plurality of candidates. The sub-tree S may be used commonly for the plurality of matching sentences T. For example, the sub-tree S of [iro (color)] in FIG. 3 may also be used for a sentence other than the main tree M of the matching sentence illustrated in FIG. 3, that is, a sentence other than the sentence “[Iro] ga suki ([Color] is favorite).” The matching sentence T may be expressed in another way other than the trie.

The matching determination unit 12 determines matching between an input sentence and a matching sentence that is set in advance and stored in the automatic response system 10 as follows. The matching is determined for each sentence of matching. The matching determination unit 12 inputs a sentence input from the input unit 11. The matching determination unit 12 divides the input sentence input by the input unit 11 into a plurality of character string units. The character string units are similar to matching sentence units and are, for example, morphemes or the like, as described above. The division into the units can be performed through, for example, morpheme analysis. When an input sentence input by the input unit 11 is already divided into the units, the matching determination unit 12 may not perform the division.

The matching determination unit 12 determines matching between the input sentence divided into the units and the matching sentence. The matching determination unit 12 compares each unit of the input sentence and each unit of the matching sentence. When the units agree with each other in addition to the order, the matching determination unit 12 determines that the sentences match each other. When the units do not agree with each other, the matching determination unit 12 determines that the sentences do not match each other. The agreement can be determined as in the determination of the matching in which a trie of the related art is used. The agreement may be determined in accordance with any method other than the foregoing method. The matching determination unit 12 outputs a response sentence associated with the matching sentence determined to match the input sentence by a rule to the response sentence output unit 13.

The plurality of candidates for the sub-tree S may be a set that includes only a plurality of candidates as in the foregoing example of “iro (color)” or may be a map that includes a correspondence relation. The map indicates, for example, a correspondence relation of key: value. The map is, for example, a correspondence relation between a country name (key) and a capital name (value). Japan: Tokyo, United

State of America: Washington DC, and the like are maps. The keys (in this example, the country names) are a plurality of candidates for the sub-tree S. A capital name corresponding to a country name matched with the input sentence may be included in a response sentence. According to the map, for example, a response sentence including a phrase corresponding to an input sentence “Sono kuni no syuto ha [syuto mei] desu. (The capital of the country is [capital name].)” can be output with regard to, for example, an input sentence “[Kokumei] no syuto ha doko (What is the capital of [country name]).”

As described above, the matching sentence T including the sub-tree S is a sentence in which a plurality of candidates is included in a part of one sentence. When the comparison for matching is performed using the matching sentence T, a consumption amount of a memory of the automatic response system 10 decreases, but a processing load (overhead) increases in some cases, compared to when (a plurality of) sentences for each of the plural candidates are used. Accordingly, for example, when the consumption amount of the memory does not increase excessively, one sentence matching sentence T including the sub-tree S may be set as the plurality of matching sentences T for each candidate to decrease the processing load.

The matching determination unit 12 may generates a matching sentence T for each of the plural candidates in accordance with at least one of the number of plural candidates included in the matching sentence T and the number of units included in the matching sentence and may determines the matching The matching determination unit 12 determines whether to determine the matching using the sub-tree S for each matching sentence T including the sub-tree S or to determine the matching without using the sub-tree S (whether to generate the plurality of matching sentences T for each of the plurality of candidates). For example, the matching determination unit 12 calculates the number of the matching sentences T in the case of generation of the matching sentence T for each candidate included in the sub-tree S from the number of plural candidates included in the matching sentence T. When the number of sub-trees S included in the matching sentence T is 1, the number of plural candidates included in the sub-tree S is that number. When the number of sub-trees S included in the matching sentence T is plural, a product of the number of plural candidates included in each sub-tree S is that number.

The matching determination unit 12 compares the calculated number of matching sentences T with a preset threshold. When the calculated number of matching sentences T is equal to or greater than the threshold, the matching determination unit 12 determines the matching using the matching sentence T including the sub-tree S. In this case, this is because the consumption amount of the memory of the automatic response system 10 increases when the plurality of sentences are used. When the calculated number of matching sentences T is less than he threshold, the matching determination unit 12 generates the matching sentence T for each candidate included in the sub-tree S and determines the matching using the plurality of generated matching sentences T. In this case, this is because the consumption amount of the memory of the automatic response system 10 does not increase excessively despite the plurality of sentences.

The above process is performed in accordance with the number of plural candidates included in the matching sentence T (the sub-tree S of the matching sentence T), but the process may be performed in accordance with the number of units included in the matching sentence instead of or in addition to the number of plural candidates. For example, when the number of units included in one or both of the main tree M and the sub-tree S is equal to or greater than a threshold, the matching is determined using the matching sentence T including the sub-tree S. When the number of units is less than the threshold, the matching sentence T for each candidate included in the sub-tree S may be generated and the matching may be determined using the plurality of generated matching sentences T.

The determination of whether to perform the matching using the sub-tree S or to perform the matching not using the sub-tree S and the generation of the matching sentence T for each candidate included in the sub-tree S are performed in advance (that is, earlier than the determination of the matching). For example, the determination and the generation are performed at a time point at which the matching sentence T or the sub-tree S is registered in the automatic response system 10.

The determination may be performed in accordance with precision for determining the matching at the time of determination of the matching. For example, the determination of the matching may be performed as follows.

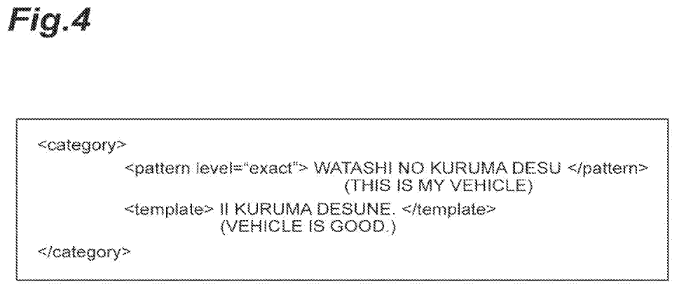

In this case, a level which is the precision for determining the matching is set in each matching sentence. Depending on the level, sentences determined to match each other can differ despite the same matching sentence. As will be described below, for example, the level is set in accordance with at least one of whether to convert a phrase included in a sentence into a reading, whether to normalize a sentence, whether to convert a phrase included in a sentence into a synonym, and whether to convert a phrase included in a sentence into a hypernym. The level is written in a portion of a level in a <pattern>tag, for example, as illustrated in FIG. 4. In the example of FIG. 4, “exact” is a level. The level is set in advance for each rule. The level is set to one of, for example, “exact,” “surface,” “normalization,” “synonym,” and “hypernym.”

For a rule in which “exact” is set as a level, the matching determination unit 12 determines matching as follows. The matching determination unit 12 determines whether character strings of an input sentence and a matching sentence completely match each other. When the character strings of the input sentence and the matching sentence completely match each other, the matching determination unit 12 determines that the input sentence matches the matching sentence. When the character strings of the input sentence and the matching sentence do not completely match each other, the matching determination unit 12 determines that the input sentence does not match the matching sentence. That is, “exact” is complete matching between the character strings. For example, for the matching sentence “Watashi no kuruma desu (This is my vehicle),” the sentences match each other only when the input sentence is “Watashi no kuruma desu (This is my vehicle).”

For a rule in which “surface” is set as a level, the matching determination unit 12 determines matching as follows. The matching determination unit 12 specifies a reading of a sentence with regard to each of the input sentence and the matching sentence. For example, when a phrase (or a word) including a kanji is included in a sentence, the phrase is converted into a reading. The conversion from the phrase into the reading can be realized, for example, based on information indicating a correspondence relation between a phrase and a reading stored in advance in the matching determination unit 12. The matching determination unit 12 determines whether the reading of the input sentence matches the reading of the matching sentence. When the reading of the input sentence matches the reading of the matching sentence, the matching determination unit 12 determines that the input sentence match the matching sentence. When the reading of the input sentence does not match the reading of the matching sentence, the matching determination unit 12 determines that the input sentence does not match the matching sentence. That is, “surface” is matching (reading matching) of homonym. For example, for the matching sentence “Watashi no kuruma desu (This is my vehicle) (“Watashi (I)” is a kanji),” the sentences match each other even when the input sentence is “Watashi no kuruma desu (This is my vehicle) (“Watashi (I)” is hiragana).”

For one or both of an input sentence and a matching sentence, the matching may be determined by performing conversion of some of the phrases into readings without performing conversion of all the phrases into readings. A combination of conversion of each phrase and non-conversion may be set as a sentence used to determine the matching. For example, for a matching sentence “karasu no nure ba iro (color of a crow with wet feathers) (“karasu (crow),” “nure (wet),” and “ba (feather)” are kanjis), a plurality of matching sentences in which some phrases such as “karasu no nure ba iro (color of a crow with wet feathers) (“karasu (crow)” is hiragana (reading) and “nure (wet)” and “ba (feather)” are kanjis),” “karasu no nure ba iro (color of a crow with wet feathers) (“karasu (crow)” and “nure (wet)” are hiragana (reading) and “ba (feather)” is kanjis),” “karasu no nure ba iro (color of a crow with wet feathers) (“karasu (crow),” “nure (wet),” and “ba (feather)” are hiragana (reading))” are converted into readings are generated and may be set as sentences used for determine the matching.

For a rule in which “normalization” is set as a level, the matching determination unit 12 determines matching as follows. The matching determination unit 12 normalizes a sentence with regard to each of an input sentence and a matching sentence. The normalization of the sentence is absorbing a variation in an expression of a sentence and conceptualizing a meaning of the sentence. Even when a sentence has a similar meaning despite a different expression, the sentence can be treated as the same sentence.

For example, when an English sentence “I can't find the way to the bus station” and an English sentence “I can never find the way to the bus station” are normalized, the sentences are treated as being the same. Since both of “can't find” and “can never find” have the negative meaning, a difference is absorbed by the normalization. Accordingly, for example, when an input sentence (a sentence input by a user) is any of the two sentences, a response “Turn right at the second traffic light” can be made by one rule.

For example, the matching determination unit 12 can normalize a sentence by removing the variation on a surface layer that has little influence on a meaning of the sentence based on a given rule using a sentence normalization method of the related art and changing a symbol string or the like that has a one-to-one correspondence with the meaning of the sentence in a preset format. The matching determination unit 12 determines whether the normalized expressions of the input sentence and the matching sentence match each other. When the expressions match each other, the matching determination unit 12 determines that the input sentence matches the matching sentence. When the expressions do not match each other, the matching determination unit 12 determines that the input sentence does not match the matching sentence. That is, “normalization” is matching after sentence normalization. For example, for the matching sentence “Watashi no kuruma desu (This is my vehicle),” the sentences match each other even when the input sentence is “Watashi no kuruma da (This is my vehicle).”

For a rule in which “synonym” is set as a level, the matching determination unit 12 determines matching as follows. The matching determination unit 12 normalizes a sentence with regard to each of an input sentence and a matching sentence. In addition, the matching determination unit 12 specifies a synonym of a phrase (or a word) included in any of two normalized sentences. The synonym can be specified, for example, based on a synonym dictionary stored in advance in the matching determination unit 12. The matching determination unit 12 determines whether normalized expressions of the input sentence and the matching sentence match each other. At this time, the matching determination unit 12 determines whether the expressions match each other even when a phrase is converted into (replaced with) a specified synonym. When the expressions match each other in one of the cases (the case of non-conversion into a synonym or the case of conversion into any synonym), the matching determination unit 12 determines that the input sentence matches the matching sentence. When the expressions do not match each other in any case, the matching determination unit 12 determines that the input sentence does not match the matching sentence. That is, “synonym” is matching after sentence normalization and synonym translation. For example, for the matching sentence “Watashi no kuruma desu (This is my vehicle),” the sentences match each other even when the input sentence is “Watashi no jidosya da (This is my automobile).” In this case, “kuruma (vehicle)” and “jidosya (automobile)” are synonyms.

For a rule in which “hypernym” is set as a level, the matching determination unit 12 determines matching as follows. The matching determination unit 12 normalizes a sentence with regard to each of an input sentence and a matching sentence. The matching determination unit 12 specifies a hypernym of a phrase (or a word) included in the normalized input sentence. The hypernym can be specified, for example, based on a hypernym dictionary stored in advance in the matching determination unit 12. The matching determination unit 12 determines whether normalized expressions of the input sentence and the matching sentence match each other. At this time, the matching determination unit 12 determines whether the expressions match each other even when a phrase is converted into (replaced with) a specified hypernym. When the expressions match each other in one of the cases (the case of non-conversion into a hypernym or the case of conversion into any hypernym), the matching determination unit 12 determines that the input sentence matches the matching sentence. When the expressions do not match each other in any case, the matching determination unit 12 determines that the input sentence does not match the matching sentence. That is, “hypernym” is matching after sentence normalization and synonym translation. For example, for the matching sentence “Watashi no kuruma desu (This is my vehicle),” the sentences match each other even when the input sentence is “Watashi no syasyu X da (This is my model X car).” In this case, “kuruma (vehicle)” is a hypernym of “syasyu X (model X car).”

Further, an input sentence which is “Watashi no kuruma desu (This is my vehicle),” does not match the matching sentence which is “Watashi no syasyu X da (This is my model X car).” This is because the hypernym of only a phrase included in the input sentence is used, as described above. This is based on the idea that it is not appropriate to match a sentence including a hyponym conception with a matching sentence including a hyponym conception because of the feature of the rule of the automatic response.

The above examples are specific examples of the levels. It is not necessary to set all the foregoing levels by the rules and only some of the foregoing levels may be used. Here, at least two levels are set to set priority for each level. Levels other than the foregoing examples may be set.

In the automatic response system 10, as described above, the plurality of rules are set and stored in advance. One of the foregoing levels is set in each rule. The matching determination unit 12 inputs the input sentence from the input unit 11. The matching determination unit 12 determines the matching between the input sentence and the matching sentence at the level in each rule and the priority corresponding to the level. The priority is set in advance in accordance with the level and is stored in the matching determination unit 12. For example, the priority is considered to be high in order in which the matching is difficult. The priority is considered to be high in the order of “exact,” “surface,” “normalization,” “synonym,” and “hypernym.” This is because a response sentence at the time of matching is thought to be appropriate for the input sentence as the matching is more difficult.

For example, the matching determination unit 12 determines the matching between the input sentence and the matching sentence in the order in which the set priority is high. The matching determination unit 12 ends the determination of the matching when there is a matching sentence determined to match the input sentence. Alternatively, the matching determination unit 12 may determine the matching between the input sentence and the matching sentence by each rule and may adopt a matching sentence with the highest priority among the matching sentences determined to match the input sentence.

The response sentence output unit 13 is a functional unit that outputs a response sentence associated in advance with the matching sentence determined to match the input sentence by the matching determination unit 12. The response sentence output unit 13 inputs the response sentence from the matching determination unit 12. The response sentence output unit 13 transmits and outputs the input response sentence to the terminal 20. The response sentence may be output by the response sentence output unit 13 in an manner other than the foregoing manner. For example, the response sentence output unit 13 may generate a voice from the response sentence through voice synthesis and may transmit and output the generated voice to the terminal 20. In this case, the response sentence output unit 13 can perform the voice synthesis using any voice synthesis method of the related art. The function of the automatic response system 10 according to the embodiment has been described above.

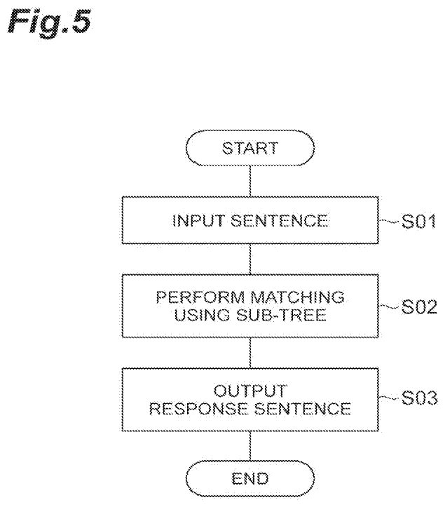

Next, a process performed by the automatic response system 10 (an operation method performed by the automatic response system 10) according to the embodiment will be described with reference to the flowchart of FIG. 5. This process is performed whenever a sentence which is an automatic response target is transmitted from the terminal 20. In this process, the input unit 11 receives and inputs a sentence (S01). Subsequently, the matching determination unit 12 determines matching between the input sentence and a matching sentence described by each rule for an automatic response. A matching sentence including a sub-tree is matched using the sub-tree (S02). Subsequently, the response sentence output unit 13 transmits and outputs a response sentence associated in advance with the matching sentence determined to match the input sentence to the terminal 20 (S03). The foregoing process is a process performed in the automatic response system 10 according to the embodiment.

In the embodiment, a matching sentence in which a plurality of candidates divided into a plurality of units are included in a part is used to determine the matching. Accordingly, the matching can be determined without preparing a plurality of matching sentences of which a part is different in advance. For example, in the example illustrated in FIG. 3, when the matching sentences such as “Karasu no nure ba iro ga suki (Color of a crow with wet feathers is favorite),” “Wine red ga suki (Wine red is favorite),” and “Ocean blue ga suki (Ocean blue is favorite)” are not prepared and a sentence “[Iro] ga suki ([Color] is favorite)” and candidates of [iro (color)] such as “karasu no nure ba iro (color of a crow with wet feathers),” “wine red,” and “ocean blue” are prepared, the matching can be determined. Accordingly, according to the embodiment, the flexible sentence matching can be performed without preparing many matching sentences. Compared to a case in which a plurality of matching sentences of which a part is different are prepared, a memory of the automatic response system 10 can be efficiently used.

In a single trie of the related art, a sentence in which a plurality of candidates formed by a plurality of units are included in a part cannot be expressed. However, by using a sub-tree as in the embodiment, it is possible to express the sentence. Accordingly, the matching can be determined using the sentence as a matching sentence.

As described above, a matching sentence for each of a plurality of candidates may be generated in accordance with the number of plural candidates included in the matching sentence and the like. In this configuration, appropriate matching can be determined in consideration of a consumption amount of the memory, a processing load, and the like of the automatic response system 10. Here, the matching sentence for each of a plurality of candidates may not be generated.

The matching may be determined at a level set for each matching sentence, as described above. For example, when it is preferable that a wide range of input sentences match a matching sentence from the viewpoint of a response sentence, a level can be set accordingly. By setting such a level, it is not necessary to prepare many matching sentences corresponding to the wide range of input sentences. Specifically, when an input sentence is desired to match a matching sentence although an expression of a sentence is different or a hypernym of a partial phrase is used, a level may be set accordingly. As described above, by setting a level (for example, “synonym” or “hypernym”) at which a wide range of input sentences match a matching sentence “Watashi no kuruma desu (This is my vehicle),” it is not necessary to prepare individual matching sentences “Watashi no kuruma da (This is my vehicle)” and “Watashi no syasyu X da (This is my model X car).”

On the other hand, when it is not preferable that a wide range of input sentences match a matching sentence, appropriate matching can be performed by setting a level accordingly. For example, when a matching sentence includes a phrase (for example, “red” or “black”) indicating specific color and this color is important from the viewpoint of a response sentence, a level at which replacement or the like of the phrase is not performed (for example, “exact” for complete match of a character string) may be set. For example, in case a matching sentence is “red” and “red” is important also for a response sentence (for example, a response sentence such as “red is favorite”), it is not preferable an input sentence is “black” matches.

When the plurality of levels are set, as described above, there is also concern of an input sentence matching a plurality of matching sentences. In the embodiment, however, since the matching is determined with the priority corresponding to the level, it is possible to match an input sentence with an appropriate matching sentence. Accordingly, according to the embodiment, the flexible sentence matching can be performed without requiring many matching sentences.

Thus, it is possible to reduce a processing load of the automatic response system 10 and it is possible to efficiently use hardware resources of the memory and the like.

By setting the levels for determining the matching, as described above, it is possible to reliably obtain the above-described advantageous effect.

A response sentence corresponding to a result of the matching as in the embodiment may be configured to be output. In this configuration, the automatic response can be made simply and appropriately as in the embodiment. Here, the matching between sentences may be performed for any objective without being necessarily performed for the automatic response. For example, the matching between sentences may be performed to search for a sentence.

In the embodiment, the automatic response is made based on the matching between sentences, but the automatic response may be made based on any method. For example, the automatic response may be made in accordance with whether an input sentence matches a specific regular expression. Alternatively, a function (a task) to be performed is determined (intended interpretation) based on an input sentence and a response corresponding to the function may be performed. For example, a weather searching function may be determined to be performed from an input sentence such as “Tell me tomorrow's weather” or “I wonder if it will be sunny tomorrow” and a response corresponding to this function may be made.

When the matching determination unit 12 determines matching between an input sentence and a matching sentence, the matching determination unit 12 reads the matching sentence stored in the storage or the like of the automatic response system 10 to the main memory included in the automatic response system 10 and determines the matching. The main memory is a working memory such as a RAM on which information which is calculation processing target is read (loaded) when a calculation process is performed on information in the automatic response system 10. When the matching is determined for each matching sentence, reading to the main memory is necessary for each matching sentence. When many candidates are included in an individual matching sentence and an amount of data of the sub-tree increases, the capacity of the main memory used to read the matching sentence also accordingly increases. When the capacity of the main memory consumed for the matching sentence increases, a speed of a calculation process such as the determination of the matching also accordingly deteriorates. Accordingly, when the matching determination unit 12 determines the matching between the input sentence and the matching sentence, a matching sentence may be read to the main memory as follows.

That is, the matching determination unit 12 reads some of a plurality of character strings included in a plurality of candidates for the matching sentence to the main memory, determines the matching between the character strings included in the sentence input by the input unit and some of the character strings, reads the character strings other than some of the character strings included in the candidates in accordance with the determination to the main memory, and determines the matching between the character strings included in the sentence input by the input unit and the character strings other than some of the character strings. Specifically, the matching determination unit 12 reads the matching sentence to the main memory and determines the matching between the input sentence and the matching sentence as follows.

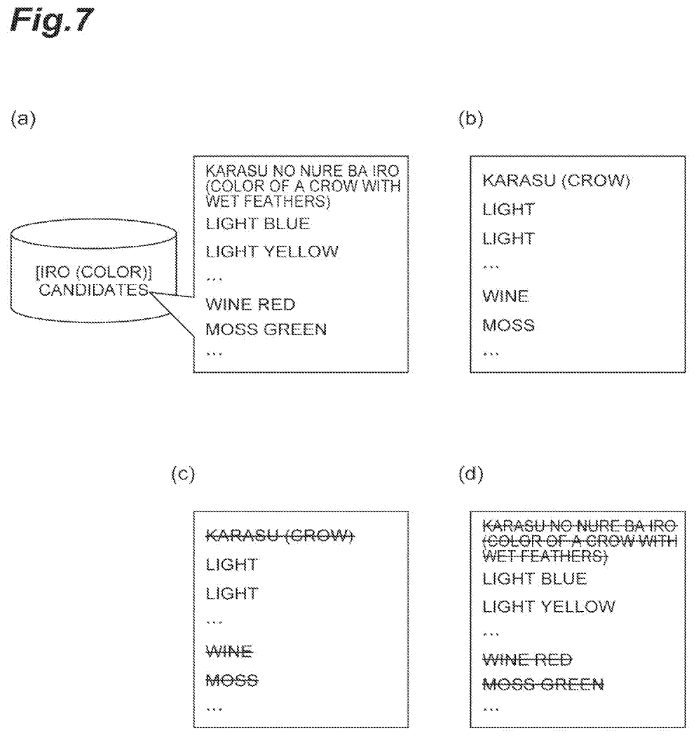

When the matching determination unit 12 determines the matching, the matching determination unit 12 reads only first character string units among the plurality of candidates included in the matching sentence which is a determination target, that is, the plurality of candidates included in the sub-tree. A case in which there are “karasu no nure ba iro (color of a crow with wet feathers),” “light blue,” “light yellow,” “wine red,” “moss green,” and the like as candidates of [iro (color)] which are the plurality of candidates included in the matching sentence, as illustrated in FIG. 7(a), will be described as an example. A plurality of candidates included in the sub-tree are associated with the matching sentence and are stored in a storage or the like of the automatic response system 10. When the matching determination unit 12 determines the matching between the input sentence and the matching sentence, the first character string units of the candidates, for example, first morphemes, are extracted from the storage or the like and are read to the main memory. In the example illustrated in FIG. 7, morphemes such as “karasu (crow),” “light,” “light,” “wine,” and “moss” illustrated in FIG. 7(b) are read to the main memory.

The matching determination unit 12 determines the matching between the first character string unit of a part corresponding to the sub-tree in the input sentence, for example, a first morpheme of the part, and each morpheme of each candidate read to the main memory. The matching is determined as in the above-described embodiment. For example, when an input sentence is “Light yellow ga suki (Light yellow is favorite)” and the part of “light yellow” is a part corresponding to the sub-tree from a relation between the input sentence and the entire matching sentence, the matching between “light” which is the first morpheme” of “light yellow” and the morpheme of each candidate read to the main memory is determined. In this case, in the example illustrated in FTG 7, as illustrated in FIG. 7(c), “light” is determined to match the input sentence among the morphemes of the candidates read to the main memory and the other morphemes (“karasu (crow),” “wine,” “moss” and the like) are determined not to match the input sentence. When a level is set in the matched sentence as in the above-described embodiment, the matching in accordance with the set level is determined. For example, the matching is determined based on a reading of the sentence (the morphemes).

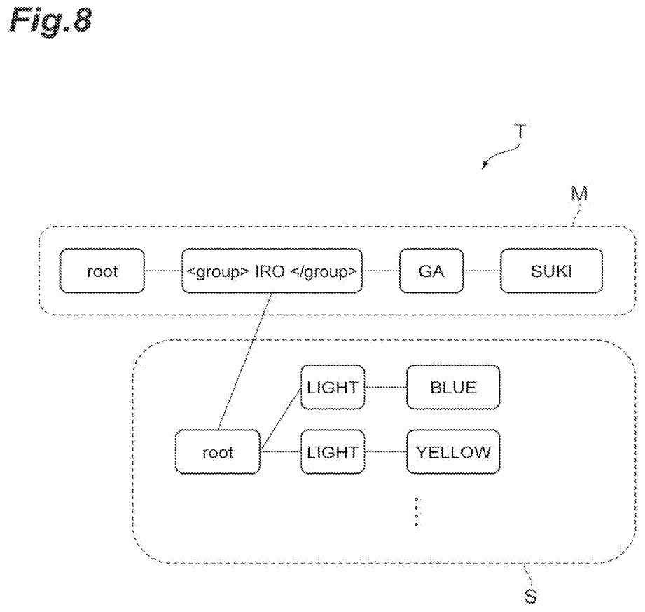

The matching determination unit 12 extracts all the character strings of only the candidates related to the morpheme determined to match the input sentence through the determination of the matching from the storage or the like and reads the character strings to the main memory. That is, the matching determination unit 12 reads only all the character strings of filtered candidates to the main memory. In the example illustrated in FIG. 7, as illustrated in FIG. 7(d), character strings of “light blue” and “light yellow” are extracted and read to the main memory. Since the first morpheme in the character string of the candidate is already read to the main memory, another morpheme may be newly read to the main memory. FIG. 8 schematically illustrates a configuration of a matching sentence T read to the main memory in this case. In this example, the matching sentence T includes a plurality of candidates in a part “[iro (color)]” in a sentence “[Iro] ga suki ([Color] is favorite).” As described above, candidates (branches) included in the sub-tree S are only candidates (branches) beginning with the morpheme “light.” In this case, as the plurality of candidates, “karasu no nure ba iro (color of a crow with wet feathers),” “wine red,” and “moss green” are also included in the storage or the like of the automatic response system 10. However, except for the head morpheme, the candidates are not read to the main memory by excluding the candidates through the filtering. This is because the candidates excluded through the filtering are not likely to match the input sentence. The matching determination unit 12 performs a process such as matching as in the above-described embodiment after only the candidates filtered as described above are read to the main memory. That is, the matching determination unit 12 determines the matching with the input sentence with regard to the character string units read to the main memory except for the first character string unit in the part corresponding to the sub-tree.

When the plurality of candidates of the matching sentence are read to the main memory step by step and selectively, as described above, an amount of data read to the main memory can decrease, that is, memory saving can be realized. Thus, it is possible to curb a decrease in a speed of a calculation process.

In the above-described example, with regard to the plurality of candidates, first (first-stage) reading to the main memory, that is, comparison with the first (first-stage) input sentence, is targeted at the first character string units of the candidates, for example, the first morphemes. However, the target may not necessarily be the first character string units and the number of character string units set in advance from the first candidate may be used. By using the plurality of units, the amount of data first read to the main memory increases, but it is possible to decrease the amount of data when all the candidates are read to the main memory.

A block diagram used to describe the foregoing embodiment illustrates a block of a functional unit. The functional block (constituent unit) is realized at least one combination of hardware and software. A method of realizing each functional block is not particularly limited. That is, each functional block may be realized using one physically or logically combined device or may be realized by connecting two or more physically or logically separated devices directly or indirectly (for example, in wired and wireless manners) and using the plurality of devices. The functional block may be realized by combining software with the one device or the plurality of devices.

The functions include determining, deciding, judging, calculating, processing, deriving, investigating, looking up, ascertaining, receiving, transmitting, outputting, accessing, resolving, selecting, choosing, establishing, comparing, assuming, expecting, considering, broadcasting, notifying, communicating, forwarding, configuring, reconfiguring, allocating or mapping, and assigning, but the present disclosure is not limited thereto. For example, a functional block (constituent unit) of causing transmitting to function is called a transmitting unit or a transmitter. As described above, a realization method is not particularly limited.

For example, the automatic response system 10 according to an embodiment of the present disclosure may function as a computer that performs a process of a method according to the present disclosure.

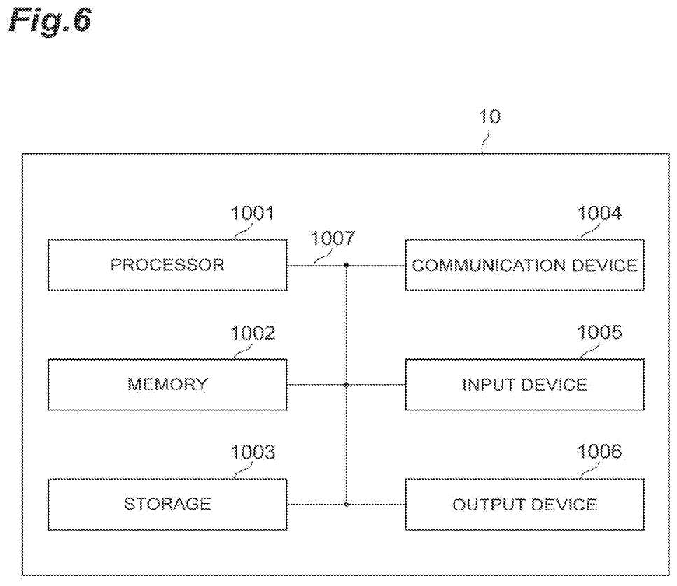

FIG. 6 is a diagram illustrating an example of a hardware configuration of the automatic response system 10 according to an embodiment of the present disclosure. The above-described automatic response system 10 may be physically configured as a computer device that includes a processor 1001, a memory 1002, a storage 1003, a communication device 1004, an input device 1005, an output device 1006, and a bus 1007.

In the following description, a word “device” can be replaced with a circuit, a device, a unit, or the like. The hardware configuration of the automatic response system 10 may include one device or a plurality of the devices illustrated in the drawing or may be configured not to include some of the devices.

Each function in the automatic response system 10 is realized by reading predetermined software (a program) on hardware such as the processor 1001 and the memory 1002 so that the processor 1001 performs calculation or causing the communication device 1004 to control communication or control at least one of reading and writing of data on the memory 1002 and the storage 1003.

The processor 1001 controls the entire computer, for example, by operating an operating system. The processor 1001 may be configured as a central processing unit (CPU) including an interface with a peripheral device, a control device, a calculation device, and a register. For example, each function in the above-described automatic response system 10 may be realized by the processor 1001.

The processor 1001 reads a program (a program code), a software module, data, and the like from at least one of the storage 1003 and the communication device 1004 to the memory 1002 to perform various processes. As the program, a program causing a computer to perform at least some of the operations described in the above-described embodiment is used. For example, each function in the automatic response system 10 may be realized by a control program that is stored in the memory 1002 and operates in the processor 1001. The above-described various processes are performed by one processor 1001, as described above, but may be performed simultaneously or sequentially by two or more processors 1001. The processor 1001 may be mounted by one or more chips. The program may be transmitted from a network via an electric communication line.

The memory 1002 is a computer-readable recording medium and may be configured by at least one of, for example, a read-only memory (ROM), an erasable programmable ROM (EPROM), an electrically erasable programmable ROM (EEPROM), a random access memory (RAM), and the like. The memory 1002 may be called a register, a cache, a main memory (a main storage device), or the like. The memory 1002 can store a program (a program code), a software module, and the like that can be executed to implement a method according to an embodiment of the present disclosure.

The storage 1003 is a computer-readable recording medium and may be configured by at least one of, for example, an optical disc such as a compact disc ROM (CD-ROM), a hard disk drive, a flexible disc, a magneto-optic disc (for example, a compact disc, a digital versatile disk, or a Blu-ray (registered trademark) disc), a smart card, a flash memory (for example, a card, a stick, a key drive), a floppy (registered trademark) disk, a magnetic strip, and the like. The storage 1003 may also be called an auxiliary storage device. The above-described storage medium may be, for example, a database, a server, or another appropriate medium including at least one of the memory 1002 and the storage 1003.

The communication device 1004 is hardware (a transceiver device) that performs communication between computers via at least one of a wired network and a wireless network and is also, for example, a network device, a network controller, a network card, a communication module, or the like. For example, each function in the above-described automatic response system 10 may be realized by the communication device 1004.

The input device 1005 is an input device (for example, a keyboard, a mouse, a microphone, a switch, a button, or a sensor) that receives an input from the outside. The output device 1006 is an output device (for example, a display, a speaker, or an LED lamp) that performs an output to the outside. The input device 1005 and the output device 1006 may be configured to be integrated (for example, a touch panel).

Each device such as the processor 1001 and the memory 1002 is connected by the bus 1007 to communicate information. The bus 1007 may be configured using a single bus or may be configured using different buses between respective devices.

The automatic response system 10 may be configured to include hardware such as a microprocessor, a digital signal processor (DSP), an application specific integrated circuit (ASIC), a programmable logic device (PLD), and a field programmable gate array (FPGA), and some or all of functional blocks may be realized by the hardware. For example, the processor 1001 may be mounted using at least one of the hardware.

Transmission of information is not limited to the aspects/embodiments described in the present disclosure and may be performed using other methods.

The order of the processing sequences, the sequences, the flowcharts, and the like of the aspects/embodiments described above in the present disclosure may be changed as long as it does not cause any inconsistencies. For example, in the methods described in the present disclosure, various steps are described as elements in an exemplary order but the methods are not limited to the described specific order.

The input or output information or the like may be stored in a specific place (for example, a memory) or may be managed in a management table. The input or output information or the like may be overwritten, updated, or added. The output information or the like may be deleted. The input information or the like may be transmitted to another device.

Determination may be performed using a value (0 or 1) which is expressed in one bit, may be performed using a Boolean value (true or false), or may be performed by comparison of numerical values (for example, comparison with a predetermined value).

The aspects/embodiments described in the present disclosure may be used alone, may be used in combination, or may be switched during implementation thereof. Transmission of predetermined information (for example, transmission of “X”) is not limited to explicit transmission, and may be performed by implicit transmission (for example, the predetermined information is not transmitted).

While the embodiments of the present disclosure have been described above in detail, it is apparent to those skilled in the art that the present disclosure is not limited to the embodiments described in this specification. The invention can be modified and altered in various forms without departing from the gist and scope of the present disclosure defined by description in the appended claims. Accordingly, description in the present disclosure is for exemplary explanation, and does not have any restrictive meaning for the present disclosure.

Regardless of whether it is called software, firmware, middleware, microcode, hardware description language, or another name, software can be widely interpreted to refer to commands, a command set, codes, code segments, program codes, a program, a sub program, a software module, an application, a software application, a software package, a routine, a sub routine, an object, an executable file, an execution thread, an order, a function, or the like.

Software, commands, information, and the like may be transmitted and received via a transmission medium. For example, when software is transmitted from a web site, a server, or another remote source using at least one of a wired technology (a coaxial cable, an optical fiber cable, a twisted-pair wire, or a digital subscriber line (DSL)) and wireless technology (infrared rays or microwaves), at least one of the wired technology and the wireless technology is included in the definition of the transmission medium.

Information, signals, and the like described in the present disclosure may be expressed using one of various different techniques.

For example, data, an instruction, a command, information, a signal, a bit, a symbol, and a chip which can be mentioned in the overall description may be expressed by a voltage, a current, an electromagnetic wave, a magnetic field or magnetic particles, a photo field or photons, or an arbitrary combination thereof.

The terms described in the present disclosure and the terms required for understanding the present disclosure may be substituted by terms having the same or similar meanings.

Information, parameters, and the like described in the present disclosure may be expressed by absolute values, may be expressed by values relative to a predetermined value, or may be expressed by other corresponding information.

Names which are used for the above-mentioned parameters are not restrictive in any viewpoint. Expressions or the like using the parameters may be different from the expressions which are explicitly disclosed in the present disclosure.

Terms such as “determining” used in the present disclosure may include various operations of various types. The “determining,” for example, may include a case in which judging, calculating, computing, processing, deriving, investigating, looking up, searching, or inquiring (for example, looking up a table, a database, or any other data structure), or ascertaining is regarded as “determining.” In addition, “determining” may include a case in which receiving (for example, receiving information), transmitting (for example, transmitting information), inputting, outputting, or accessing (for example, accessing data in a memory) is regarded as “determining ” Furthermore, “determining” may include a case in which resolving, selecting, choosing, establishing, comparing, or the like is regarded as “determining.” In other words, “determining” includes a case in which a certain operation is regarded as “determining.” Further, “determining” may be replacing with reading such as “assuming,” “expecting,” or “considering.”

Terms “connected” and “coupled” or such all modifications mean all direct or indirect connection or coupling between two or more elements and may include locating one or more intermediate elements between two “connected” or “coupled” elements. Connection or coupling between elements may be physical or logical, or physical and logical connections or couplings may be combined. For example, “connection” may be replaced with “access.” In the case of use in the present disclosure, two elements may be believed to “connected” or “coupled” using at least one of one or more electric wires, cables, and printed electric connections and using electromagnetic energy or the like with a wavelength of a wireless frequency domain, a microwave domain, and a light (both visible light and invisible light) domain as non-limiting and non-inclusive examples.

Description of “on the basis of” used in the present disclosure does not mean “only on the basis of” unless otherwise mentioned. In other words, description of “on the basis of” means both “only on the basis of” and “at least on the basis of.”

As long as “include,” “including,” and modifications thereof are used in the present specification, such terms are intended to be inclusive like a term “comprising.” In addition, a term “or” used in the present disclosure is intended to be not an exclusive logical sum.

In the present disclosure, for example, when articles such as a, an, and the in English are added in translation, the present disclosure may include plural forms of nouns after such articles.

In the present disclosure, a term “A and B are different” may mean that “A and B are mutually different.” This term may mean that “A and B are each different from C.” Terms such as “separated” and “coupled” may be interpreted similarly as “different.”

### REFERENCE SIGNS LIST

10: Automatic response system
11: Input unit
12: Matching determination unit
13: Response sentence output unit
20: Terminal
1001: Processor
1002: Memory
1003: Storage
1004: Communication device
1005: Input device
1006: Output device
1007: Bus

1. A sentence matching system comprising circuitry configured to:
input a sentence; and
determine matching between the input sentence and a preset matching sentence,
wherein the matching sentence is configured to be divided into a plurality of character string units and at least one of the character string units includes a plurality of candidates further divided into a plurality of character strings, and
the circuitry determines the matching by treating the input sentence as divided into the plurality of character string units.

2. The sentence matching system according to claim 1,
wherein the circuitry generates a matching sentence for each of the plural candidates in accordance with at least one of the number of plural candidates included in the matching sentence and the number of units included in the matching sentence and determines the matching.

3. The sentence matching system according to claim 1,
wherein, precision used to determine the matching in accordance with the matching sentence is set in the matching sentence, and
the circuitry determines the matching at the precision and priority corresponding to the precision for each matching sentence.

4. The sentence matching system according to claim 3, wherein the precision is set in accordance with at least one of whether to convert a phrase included in a sentence into a reading, whether to normalize the sentence, whether to convert a phrase included in the sentence into a synonym, and whether to convert the phrase included in the sentence into a hypernym.

5. The sentence matching system according to claim 1,
wherein the circuitry outputs a response sentence associated in advance with the matching sentence determined to match the input sentence.

6. The sentence matching system according to claim 1, wherein the circuitry reads some of the plurality of character strings included in the plurality of candidates to a main memory of the sentence matching system, determines the matching between the character strings included in the input sentence and some of the character strings, reads the character strings other than some of the character strings included in the candidates in accordance with the determination to the main memory, and determines the matching between the character strings included in the input sentence and the character strings other than some of the character strings.

7. The sentence matching system according to claim 2,
wherein, precision used to determine the matching in accordance with the matching sentence is set in the matching sentence, and
the circuitry determines the matching at the precision and priority corresponding to the precision for each matching sentence.
